(19) United States
(12) Patent Application Publication
(10) Pub. No.: US 2007/0206178 A1
(43) Pub. Date: Sep. 6, 2007

(54) Speed measuring device

(75) Inventors: Isaac Chiang, Gueishan Township (TW); Wen-Bin Lai, Taoyuan City (TW)

Correspondence Address: CHARLES E. BAXLEY, ESQ., 90 JOHN STREET, THIRD FLOOR, NEW YORK, NY, 10038, US

(73) Assignee: Tron Link Technology Co., Ltd.

(21) Appl. No.: 11/358,749

(22) Filed: Feb. 21, 2006

(51) Int. Cl. G01P 3/36

(52) U.S. Cl. 356/28

(57) ABSTRACT

A speed measuring device provided by the present invention comprises a base, a speed measuring circuit, and two speed measuring units. The two speed measuring units are installed on the base and located a distance away from each other. The microprocessor outputs a signal to the pulse generator, the pulse generator produces pulses and send them to the first and second frequency oscillators, letting the first and second frequency oscillators send two frequency signals to the respective infrared emitters, and then the respective infrared emitters emit infrared signals with different frequency. When the moving object passes through different areas irradiated by the different frequency infrared signals, the different frequency infrared signals will be reflected to the infrared receivers. Finally, the infrared receivers send two detecting signals to the microprocessor, allowing the microprocessor to figure out the motion data of the moving object.

### BACKGROUND OF THE INVENTION

1. Field of the Invention

The present invention relates to a speed measuring device that is capable of measuring the speed of a ball used in ball games, and the speed of a ball equipment, such as swing speed and bat speed.

2. Description of the Prior Art

In a ball game, the speed of the ball, the swing speed or the bat speed is usually one of the key factors determining the outcome of the game. Hence, the player will particularly measure and analyze the swing speed or the bat speed, or the speed of the ball he pitched or kicked, in order to maximize the potential to the full by improving his skill at games or to improve the apparatus,

In the past, it must develop an appropriative speed measuring device in order to detect the speed of the ball or the swing or bat speed, and the appropriative speed measuring device is high cost and difficult to assemble. Most of the speed measuring devices use laser detecting technology, therefore, the before-use adjustment is quite time consuming and requires high precision. The use of the speed measuring device is usually limited by courts and fields and is unable to satisfy the user's needs.

For example, the speed gun commonly seen in the baseball field is to measure the speed based on the emission and feedback of the wave. Sine the speed is only measurable when the wave is different when it is received compared to when it was emitted (based on the Doppler effect), the speed gun must be optimally placed on the line extended from the path along which the ball is pitched, otherwise, only the real value of speed at a specific angle can be obtained, thus the correct speed values that the speed gun can obtained will be much decreased. In addition, this type speed gun still has the following unsolvable problems.

First, if the object to be measured moves nonlinearly or it is impossible to set the speed gun along the same path as the ball travels, the speed measuring device using the wave emission and feedback will be unable to measure the speed.

Second, when the speed of the object to be measured is only valid within a small distance, it is impossible for the speed measuring device using the wave emission and feedback to obtain an appropriate value (the same speed may lead to much different result), due to the wave is much different when it is received compared to when it was emitted.

The present invention has arisen to mitigate and/or obviate the afore-described disadvantages.

### SUMMARY OF THE INVENTION

The primary objective of the present invention is to provide a light weight and easily operable speed measuring device.

A speed measuring device provided by the present invention comprises a base, a speed measuring circuit, and two speed measuring units. The two speed measuring units are installed on the base and located a distance away from each other. During movement, a moving object will move through different areas irradiated by the different frequency infrared signals, the different frequency infrared signals will be reflected by a surface of the moving object and will be received by the infrared receivers of the respective speed measuring units. In this way, the motion data of the moving object can be figured out by taking the use of the two detecting signals, the time difference of the two detecting signals and the fixed distance between the first and second speed measuring units.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a speed measuring device in accordance with a first embodiment of the present invention;

FIG. 2 is a perspective view of showing the first and second support seats in accordance with the first embodiment of the present invention;

FIG. 3 is a cross sectional view of showing the first and second support seats in accordance with the first embodiment of the present invention;

FIG. 4 is an illustrative view of showing a speed measuring circuit in accordance with the first embodiment of the present invention;

FIG. 5 is a circuit diagram of the speed measuring circuit in accordance with the first embodiment of the present invention;

FIG. 6 is an operational view of the first embodiment of the present invention;

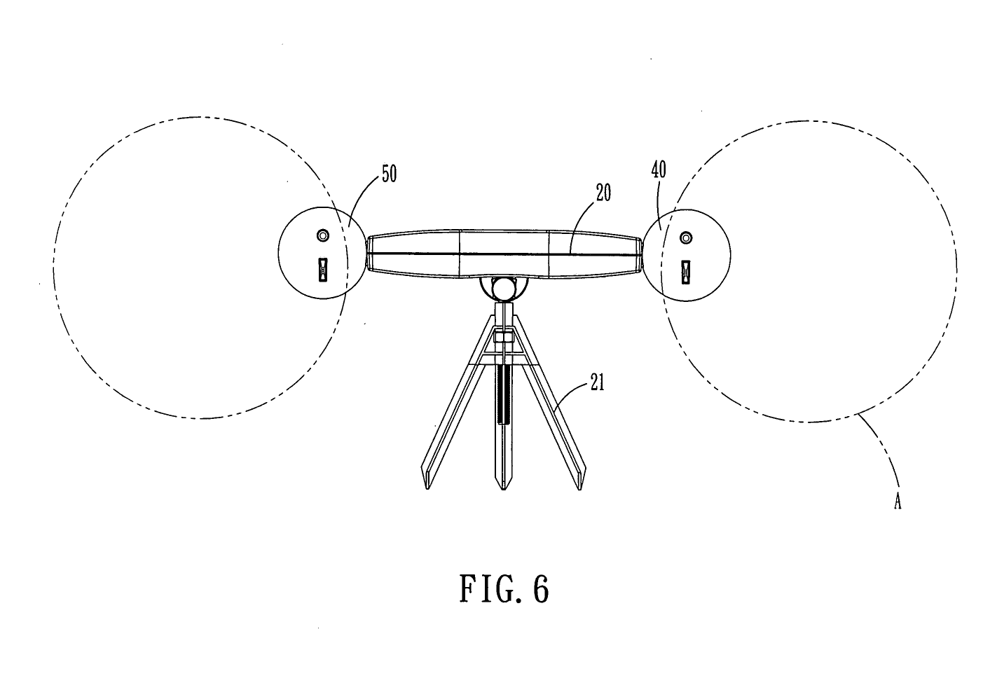

FIG. 7 is another operational view of the first embodiment of the present invention, wherein the base is slanted;

FIG. 8 is a perspective view of a speed measuring device in accordance with a second embodiment of the present invention;

FIG. 9 is an illustrative view of showing a speed measuring circuit in accordance with the second embodiment of the present invention;

FIG. 10 is a circuit diagram of the speed measuring circuit in accordance with the second embodiment of the present invention; and

FIG. 11 is an operational view of the second embodiment.

### DETAILED DESCRIPTION OF THE PREFERRED EMBODIMENTS

The foregoing, and additional objects, features and advantages of the present invention will become apparent from the following detailed description of preferred embodiments thereof, taken in conjunction with the accompanying drawings.

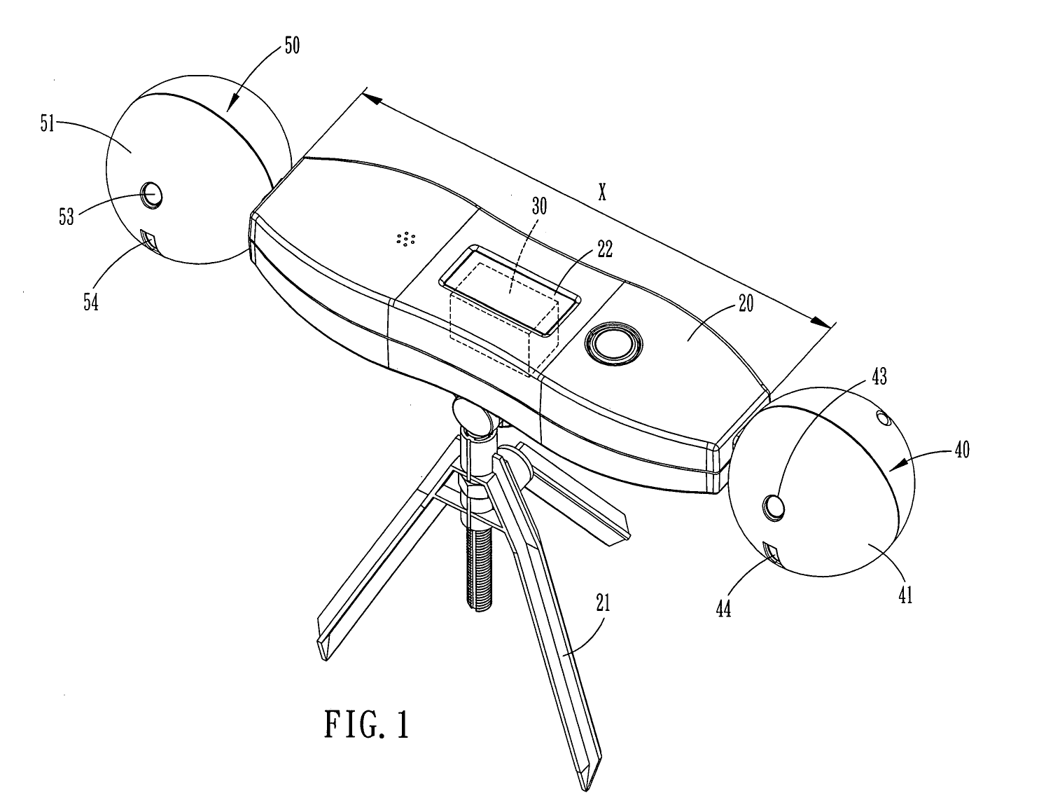

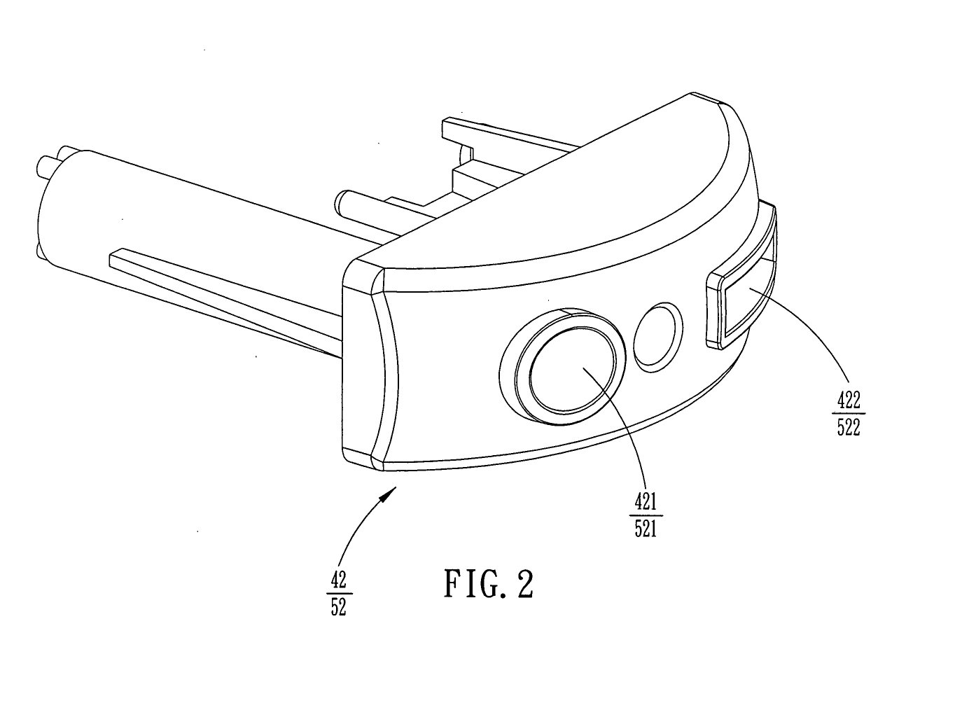

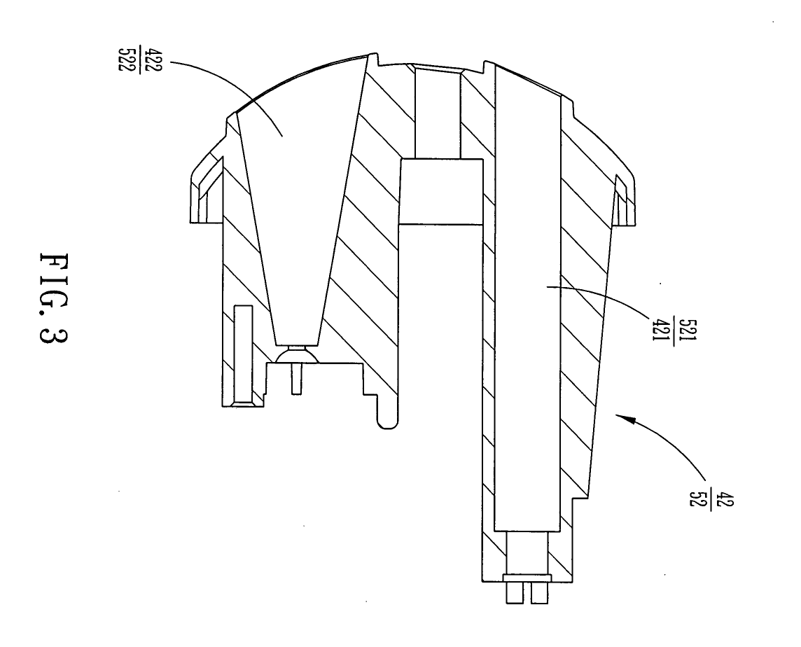

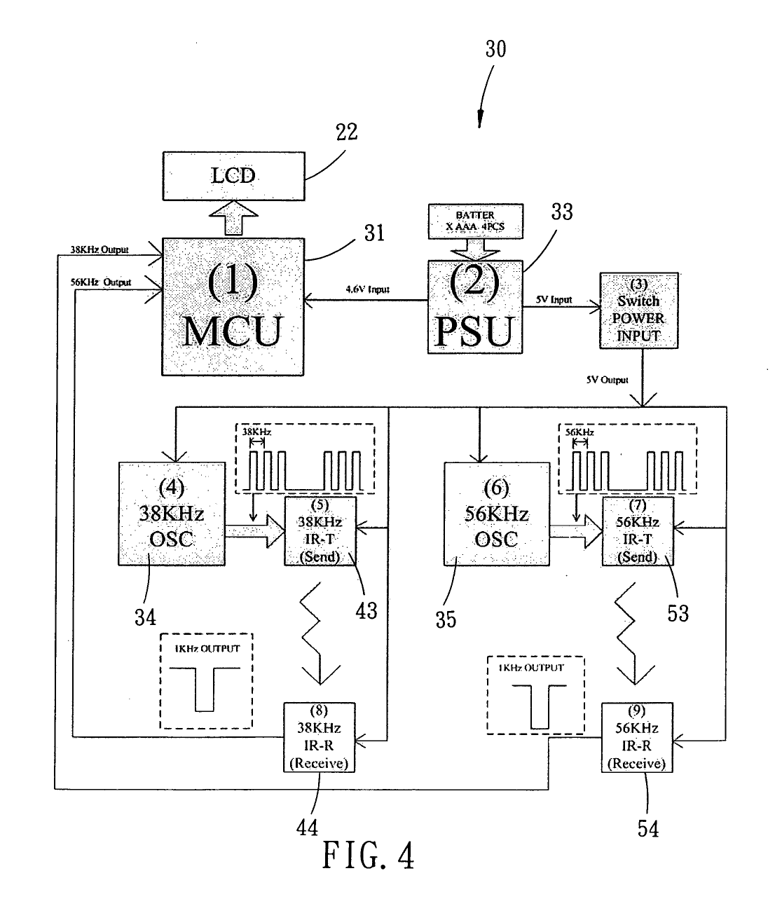

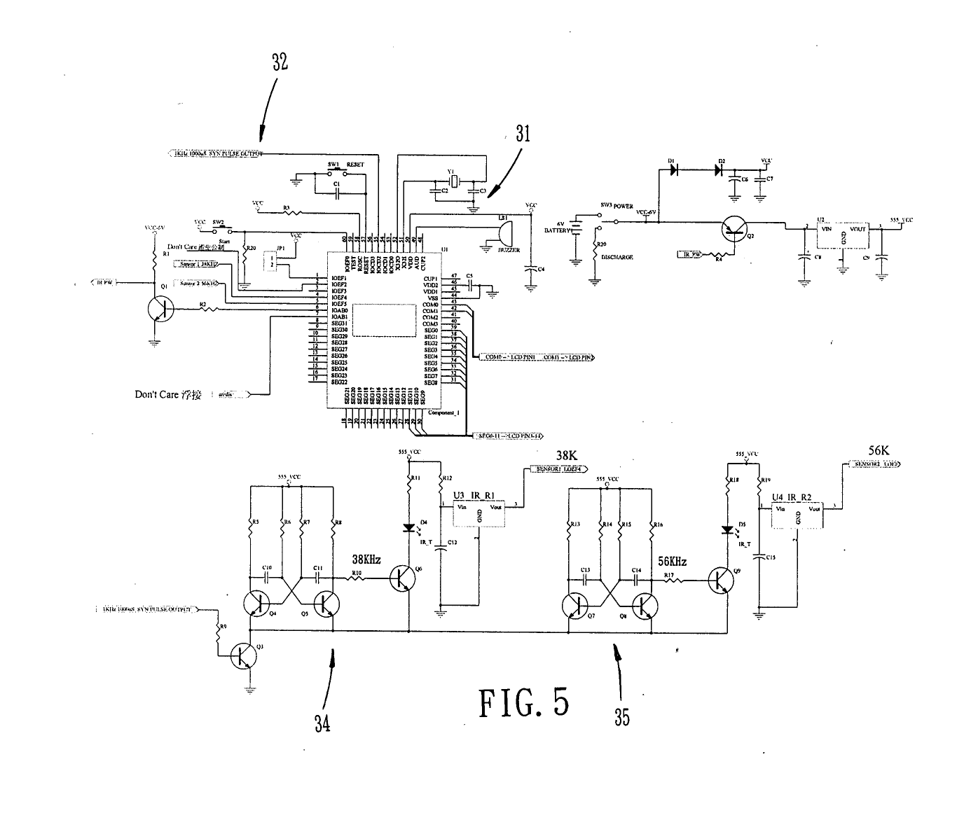

Referring to FIGS. 1-5, a speed measuring device in accordance with a first embodiment of the present invention is illustrated and comprises a base 20, a speed measuring circuit 30, a first speed measuring unit 40 and a second speed measuring unit 50.

A support frame 21 is installed at the bottom of the base 20 and can be adjusted to adjust the angle and the distance between the support frame 21 and the base 20. And a display 22 is further installed on the base 20.

The speed measuring circuit 30 includes a microprocessor 31, a pulse generator 323, a power supply unit (PSU) 33, a first frequency oscillator 34 and a second frequency oscillator 35.

The first speed measuring unit 40 includes a first spherical shell 41, a first support seat 42, a first infrared emitter 43 and a first infrared receiver 44. The first spherical shell 41 is mounted at an end of the base 20, and the first support seat 42 is disposed in the first spherical shell 41. An emitting tube 421 and a receiving tube 422 are installed on the first support seat 42, and the distance between the emitting and the receiving tubes 421 and 422 is 20-40 mm. The first infrared emitter 43 and the first infrared receiver 44 are received in the emitting tube 421 and the receiving tube 422, respectively. The emitting tube 421 is a straight structure whose diameter ranges 5-10 mm, and length is 30-50 mm. The receiving tube 422 has a slot and a funneled inner structure, the slot is 20-40 mm long and 3-6 mm wide, and the receiving pipe 422 is 30-50 mm long.

The second speed measuring unit 50 includes a second spherical shell 51, a second support seat 52, a second infrared emitter 53 and a second infrared receiver 54. The second spherical shell 51 is mounted at another end of the base 20 and located a distance X away from the first speed measuring unit 40. The second support seat 52 is received in the second shell 51 (the second support seat 52 is exactly identical to the first support seat 42, so the reference Nos 52 and 42 are juxtaposed in drawings). An emitting tube 521 and a receiving tube 522 are installed on the second support seat 52, and the distance between the emitting and the receiving tubes 521 and 522 is 20-40 mm. The second infrared emitter 53 and the second infrared receiver 54 are received in the emitting tube 521 and the receiving tube 522, respectively. The emitting tube 521 is a straight structure whose diameter ranges 5-10 mm, and length is 30-50 mm. The receiving tube 522 has a slot and a funneled inner structure, the slot is 20-40 mm long and 3-6 mm wide, and the receiving pipe 522 is 30-50 mm long.

The operation and function of the first embodiment is explained below, in this embodiment the moving object is a football for example.

When the speed measuring device is started, the microprocessor 31 will output a signal to the pulse generator 32, and the pulse generator 32 will produce 1 KHz pulses and send them to the first and second oscillators 34 and 35. The first oscillator 34 sends 38 KHz frequency to the first infrared emitter 43 for enabling it to generate a first infrared at a frequency of 38 KHz. Meanwhile, the second oscillator 35 sends 56 KHz frequency to the second infrared generator 53 for enabling it to generate a first infrared at a frequency of 56 KHz.

Before measuring the speed of the football A, the kicker should stand at a side of the speed measuring device, and the route the football A travels after being kicked off is predetermined to pass through the first and second speed measuring units 40 and 50, letting the football A pass through a first frequency infrared irradiated area and a second frequency infrared irradiated area successively. During the traveling course, the surface of the football A will shut out the first frequency infrared irradiated area and the second frequency infrared irradiated area successively, so that the first frequency infrared and the second frequency infrared will be reflected and received by the first and second infrared receivers 44 and 54. And then the first and second infrared receivers 44 and 54 will send out two detecting signals to the microprocessor 31 of the speed measuring circuit 30, allowing the microprocessor 31 to figure out the motion data of the football A, based on the two detecting signals, the time difference of the two detecting signals and the fixed distance between the first and second speed measuring units 40 and 50. The motion data (such as the acceleration, the speed and the traveling time of the football) will be displayed on the display 22.

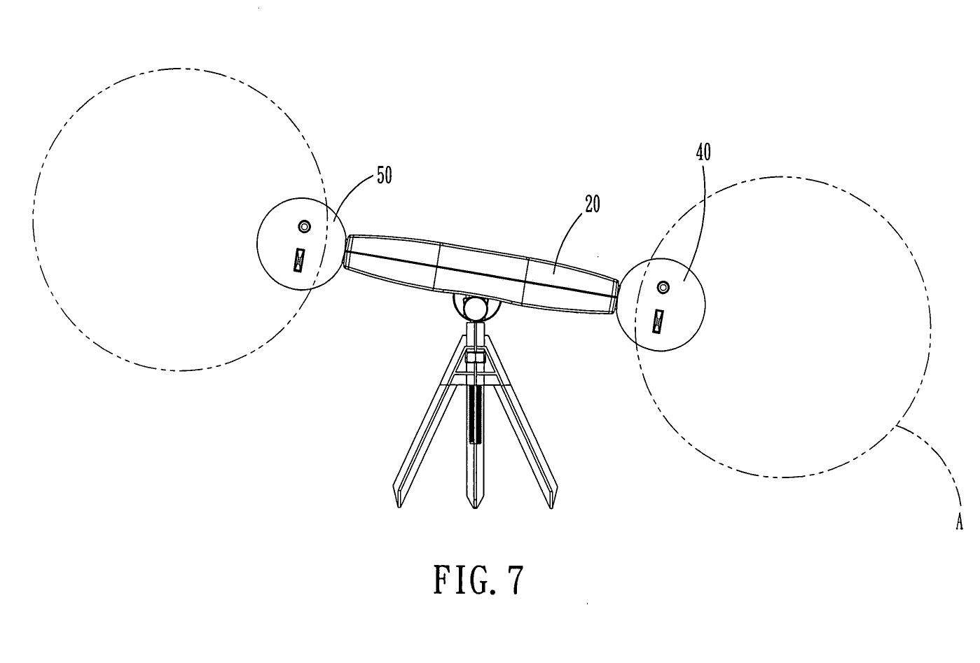

In addition, as shown in FIG. 7, since the base 20 is placed on the support frame 21 that is adjustable with respect to the base 20 in terms of angle and distance, when the present invention is used to measure the speed of the football A kicked from different angles, the user can use the support frame 21 to incline the base 20 to any desired angle from which the football A is to be kicked. Therefore, the present invention is an easily operable speed measuring device capable of figuring out the motion data of a short distance moving object.

### Embodiment 2

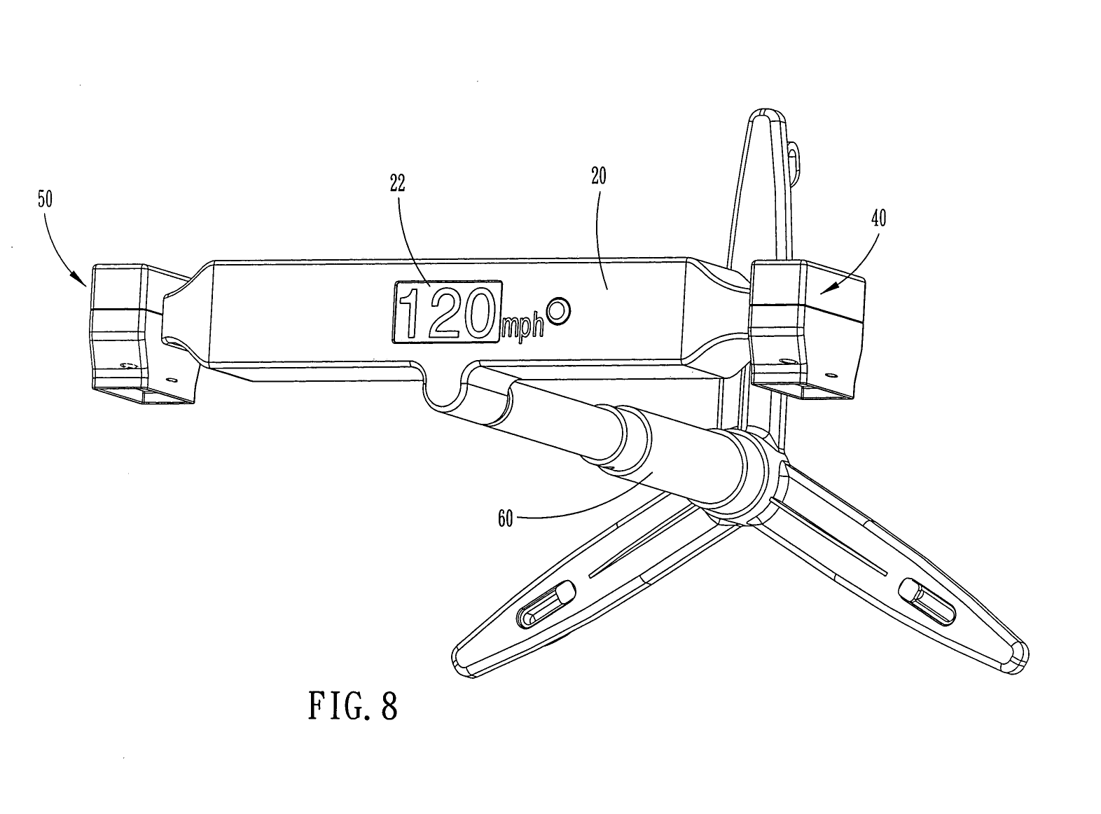

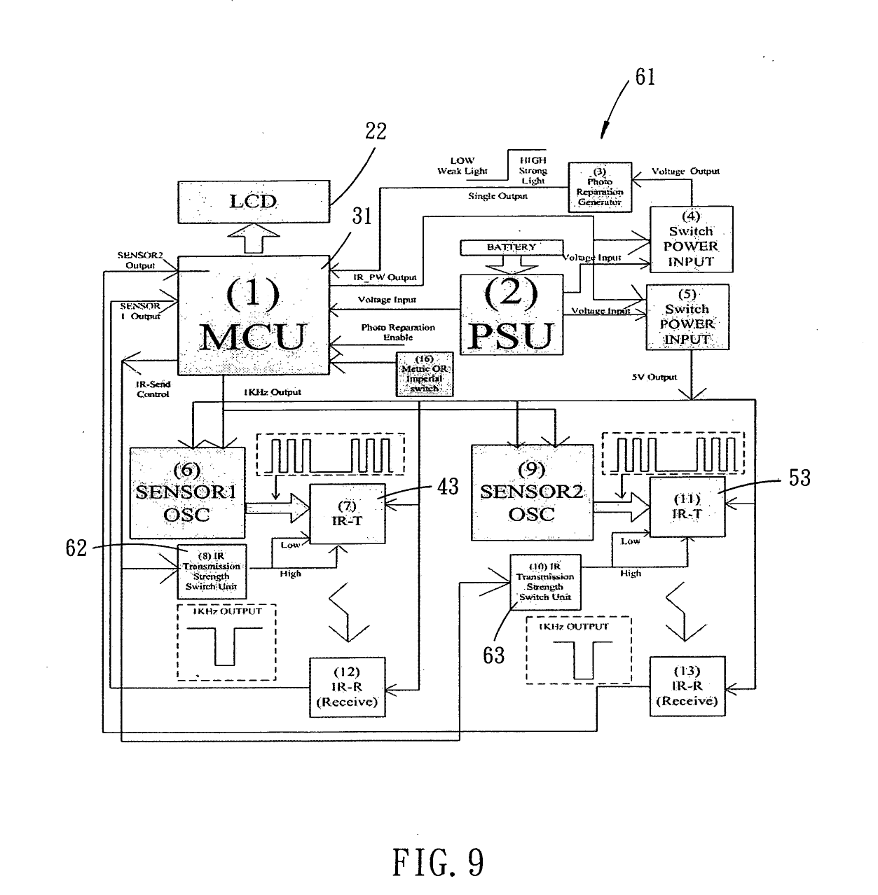

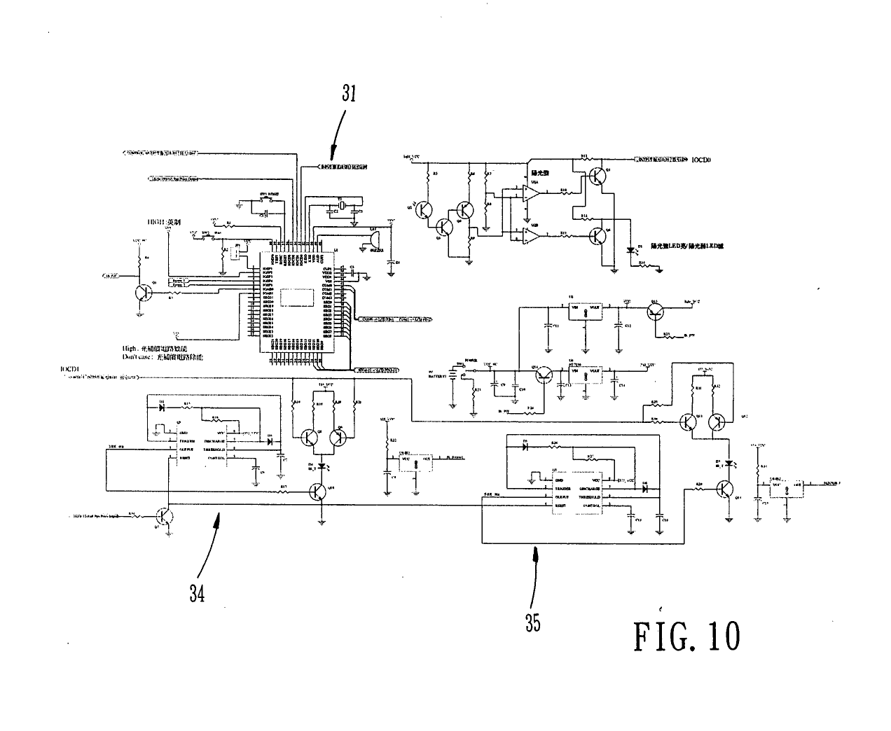

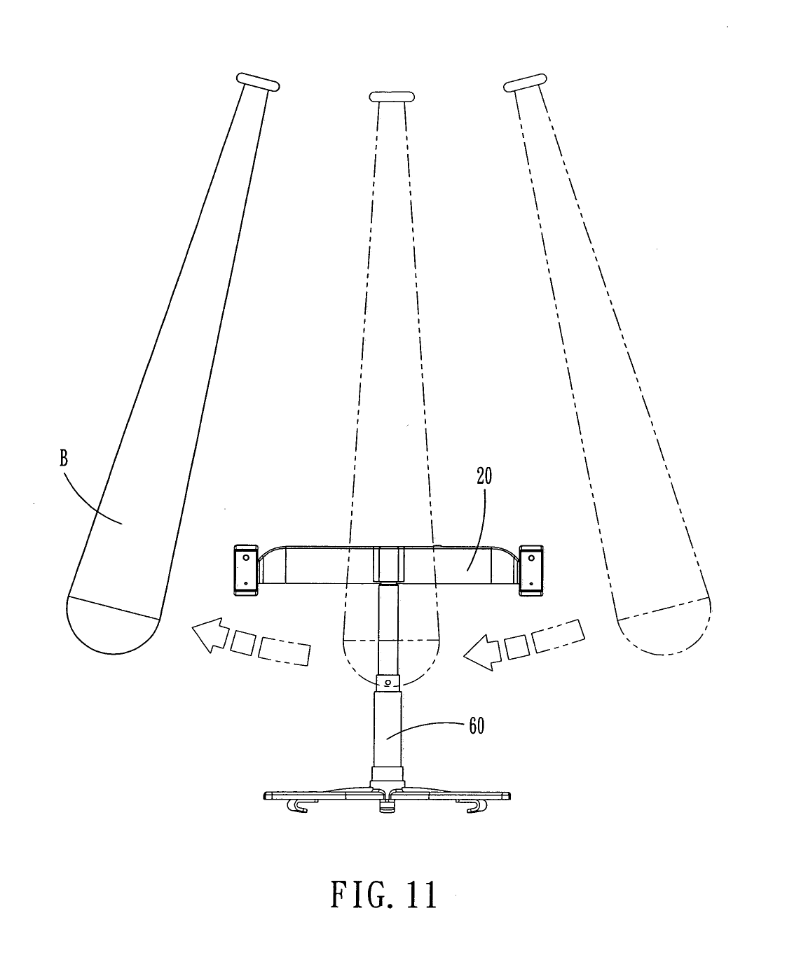

Referring to FIGS. 8-11, the base 20 of the present invention is installed on a telescopic support frame 60 so that the speed measuring range can be adjusted at any time, and the support frame 60 can be mounted on a wall. For example, as shown in FIG. 11, the speed measuring device is used to measure the speed of a baseball batted by a bat B. The speed measuring circuit 30 of this embodiment comprised of a microprocessor 31, a pulse generator and an input voltage switching device.

The second embodiment is additionally provided with a photo reparation generator 61 that is connected to the microprocessor 31 of the speed measuring circuit 30. The first and second speed measuring units 40 and 50 are equipped with an infrared transmission strength switch unit 62 and 63, respectively. The infrared transmission strength switch unit 62 is connected to the first infrared emitter 43 and the microprocessor 31, and the infrared transmission strength switch unit 63 is connected to the microprocessor 31 and the second infrared emitter 53.

After the photo reparation generator 61 detected the light intensity of the environment, it will send a signal to the microprocessor 31, and the microprocessor 31 will transmit a control signal to the infrared transmission strength switch units 62 and 63, allowing the infrared transmission strength switch units 62 and 63 to send high or low signals to the first and second infrared emitters 43 and 53. With the photo reparation generator 61 and the infrared transmission strength switch units 62 and 63, the present invention will not be affected by the light intensity of the environment.

It will be noted that the inner periphery of the emitting tube and the receiving tube on the first support seat can be arranged with light shielding member for protecting the speed measuring operation from the influence of illumination light.

While we have shown and described various embodiments in accordance with the present invention, it should be clear to those skilled in the art that further embodiments may be made without departing from the scope of the present invention.

What is claimed is:

1. A speed measuring device for measuring the speed of a moving object, comprising:
a base equipped with a support frame and a display;
a speed measuring circuit comprised of a microprocessor, a pulse generator, a first frequency oscillator and a second frequency oscillator;
a first speed measuring unit mounted on the base and connected to the speed measuring circuit, the first speed measuring unit comprised of a first infrared emitter and a first infrared receiver; and
a second speed measuring unit mounted on the base and located a distance away from the first speed measuring unit and connected to the speed measuring circuit, the second speed measuring unit comprised of a second infrared emitter and a second infrared receiver;
by such arrangements, the microprocessor will output a signal to the pulse generator, and the pulse generator will produce pulses and send them to the first and second frequency oscillators, letting the first and second frequency oscillators send two frequency signals to the respective infrared emitters, and then the respective infrared emitters will emit infrared signals with different frequency, when the moving object passes through different areas irradiated by the different frequency infrared signals, the different frequency infrared signals will be reflected by a surface of the moving object and will be received by the infrared receivers of the respective speed measuring units, and finally, the infrared receivers will send two detecting signals to the microprocessor of the speed measuring circuit, thus allowing the microprocessor to figure out the motion data of the moving object.

2. The speed measuring device as claimed in claim 1 further comprising a first support seat and a second support seat, an emitting tube and a receiving tube mounted on each of the first support seat and the second support seat for accommodation of the first and second infrared emitters and the first and second infrared receivers, respectively.

3. The speed measuring device as claimed in claim 2 further comprising a plurality of light shielding members arranged on an inner surface of the emitting tubes and the receiving tubes on the respective support seats.

4. The speed measuring device as claimed in claim 2, wherein each of the emitting tubes is a straight structure whose diameter ranges 5-10 mm, and length is 30-50 mm, each of the receiving tubes is defined with a slot and has a funneled inner structure, the slot is 20-40 mm long and 3-6 mm wide, and each of the receiving pipes is 30-50 mm long.

5. The speed measuring device as claimed in claim 3, wherein a distance between a center of the emitting tube and a center of the receiving tube is 20-40 mm.

6. The speed measuring device as claimed in claim 1 further comprising a power supply unit (PSU) connected to the speed measuring circuit.

7. A speed measuring device for measuring the speed of a moving object, comprising:
a base equipped with a support frame and a display;
a speed measuring circuit comprised of a microprocessor, a pulse generator and an input voltage switching device, the microprocessor enabling the pulse generator to produce pulses;
a photo reparation generator connected to the microprocessor of the speed measuring circuit;
a first speed measuring unit mounted on the base and connected to the speed measuring circuit, the first speed measuring unit comprised of a first infrared emitter and a first infrared receiver;
a second speed measuring unit mounted on the base and located a distance away from the first speed measuring unit and connected to the speed measuring circuit, the second speed measuring unit comprised of a second infrared emitter and a second infrared receiver;
one infrared transmission strength switch unit connected to the first infrared emitter and the microprocessor, and another infrared transmission strength switch unit connected to the microprocessor and the second infrared emitter;
by such arrangements, after the photo reparation generator detected the light intensity of the environment, it will send a signal to the microprocessor, allowing the microprocessor transmit signals to the respective infrared transmission strength switch units, and then the respective infrared transmission strength switch units will send high or low signals to the first and second infrared emitters.

8. The speed measuring device as claimed in claim 7 further comprising a first support seat and a second support seat, an emitting tube and a receiving tube mounted on each of the first support seat and the second support seat for accommodation of the first and second infrared emitters and the first and second infrared receivers, respectively.

9. The speed measuring device as claimed in claim 8 further comprising a plurality of light shielding members arranged on an inner surface of the emitting tubes and the receiving tubes on the respective support seats.

10. The speed measuring device as claimed in claim 8, wherein each of the emitting tubes is a straight structure whose diameter ranges 5-10 mm, and length is 30-50 mm, each of the receiving tubes is defined with a slot and has a funneled inner structure, the slot is 20-40 mm long and 3-6 mm wide, and each of the receiving pipes is 30-50 mm long.

11. The speed measuring device as claimed in claim 9, wherein a distance between a center of the emitting tube and a center of the receiving tube is 20-40 mm.

12. The speed measuring device as claimed in claim 7 further comprising a power supply unit (PSU) connected to the speed measuring circuit.
